(19) United States
(12) Patent Application Publication
(10) Pub. No.: US 2021/0398277 A1
(43) Pub. Date: Dec. 23, 2021

(54) NO RESULTS INDICATOR FOR STACK OF IMAGES

(71) Applicant: FOVIA, INC., Palo Alto, CA (US)

(72) Inventors: David WILKINS, Allison Park, PA (US); Kevin KREEGER, Palo Alto, CA (US)

(73) Assignee: FOVIA, INC., Palo Alto, CA (US)

(21) Appl. No.: 17/349,647

(22) Filed: Jun. 16, 2021

Related U.S. Application Data
(60) Provisional application No. 63/040,399, filed on Jun. 17, 2020.

(51) Int. Cl. G06T 7/00; G06K 9/32; G06N 20/00

(52) U.S. Cl. CPC G06T 7/0012; G06N 20/00; G06K 9/3233

(57) ABSTRACT

A process for alerting a user of no results or no abnormalities with respect to a stack of medical images is described. The process includes determining if a stack of medical images has been analyzed for findings (e.g., of areas of interest in medical images). In accordance with a determination that the stack of medical images has been analyzed for findings and no findings have been found, displaying an indication that the stack of medical images has no findings, and in accordance with a determination that the stack of medical images has findings, displaying an indication that the stack of medical images has findings (and in some examples, indicating the number of findings in the stack of images).

### CROSS-REFERENCE TO RELATED APPLICATIONS

This application claims the benefit of U.S. Provisional Patent Application No. 63/040,399, entitled, “NO RESULTS INDICATOR FOR STACK OF IMAGES,” filed Jun. 17, 2020, the content of which is hereby incorporated by reference in its entirety for all purposes.

### FIELD

This relates generally to assisting with viewing and interpreting a stack of medical images.

### SUMMARY

According to one embodiment, an indicator is used for alerting a user of no results or no abnormalities with respect to a stack of medical images. In one example, a process for indicating findings for a stack of medical images includes determining if a stack of medical images has been analyzed for findings (e.g., of areas of interest in medical images). In accordance with a determination that the stack of medical images has been analyzed for findings and no findings have been found, displaying an indication that the stack of medical images has no findings. Further, in some examples, in accordance with a determination that the stack of medical images has not been analyzed for findings, displaying an indication that the stack of medical images has not been analyzed.

In some examples, in accordance with a determination that the stack of medical images has not been analyzed for findings, displaying an indication that the stack of medical images has not been analyzed, and in accordance with a determination that the stack of medical images has been analyzed for findings, displaying an indication that the stack of medical images has been analyzed for findings (and in some examples, indicating there are no findings or the number of findings in the stack of images (e.g., indicating 0, 1, 2, etc. findings within the stack of images).

In some examples, the indication may further include an indication of the process used to analyze the stack of images. For example, the process may include various artificial intelligence, machine learning, and/or computer aided discovery processes for identifying areas of interest in medical images.

According to other embodiments, a system and computer readable storage medium comprising instructions for displaying an indication of findings is provided. In particular, including instructions for determining if a stack of medical images has been analyzed for findings, and in accordance with a determination that the stack of medical images has not been analyzed for findings, displaying an indication that the stack of medical images has not been analyzed. The instructions further comprising instructions for, in accordance with a determination that the stack of medical images has been analyzed for findings, displaying an indication that the stack of medical images has been analyzed for findings.

### BRIEF DESCRIPTION OF THE DRAWINGS

FIG. 1 illustrates various embodiments for displaying a no results indication or a findings indication for a stack of medical images.

FIG. 2 illustrates an exemplary process for determining and displaying a no finding indication and/or a findings indication.

FIG. 3 illustrates an exemplary system for visualization of medical images.

### DETAILED DESCRIPTION

There are many types of machine learning or AI algorithms to assist radiologists in interpreting medical imaging studies. These include algorithms to assist in actual reading of the scanned images, algorithms to automatically find prior imaging studies of the patient, algorithms to make predictions based on other patient information than just the images, algorithms that help scheduling in the scanner rooms, algorithms that assist in deciding what scans should be done, and many more.

The AI algorithms used to help detect or interpret disease can be further subdivided into several categories. These include algorithms that classify disease, algorithms that measure structures in the images, algorithms that segment structures in the images, and many more.

This disclosure relates to algorithms that detect or classify the disease in the images. Furthermore, this disclosure addresses algorithms commonly knows a CAD (Computer Aided Detection) where the algorithm highlights multiple suspicious areas of abnormalities in the images.

Once a stack of medical images has been processed by one or more algorithms to identify areas of interest, a medical professional or physician typically reviews the findings to accept/reject (or even edit) each of the findings. When these types of algorithms are run on medical imaging modalities, the multiple findings may not be visible all at once within a stack of medical images. Accordingly, the physician typically must scroll up and down through the image stack searching for the findings. It should be noted that a given study may have one or more stacks of images, where each stack may or may not have been processed for findings, e.g., by an AI algorithm.

It would be advantageous to know at the beginning, of even before the study is opened, that there are no findings in a particular stack of medical images. In that way, the physician knows there is no need to search for findings in that stack of images. Further, in this situation, it is important that the physician can differentiate between an image stack where an algorithm has been executed and found no results and an image stack where the algorithm has not been executed, which in the latter case is not classified as “No Findings” since this image stack was not processed.

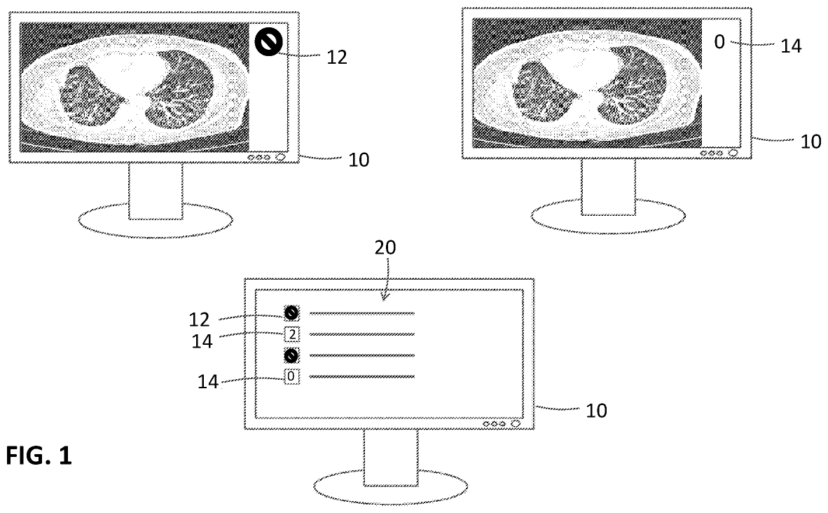

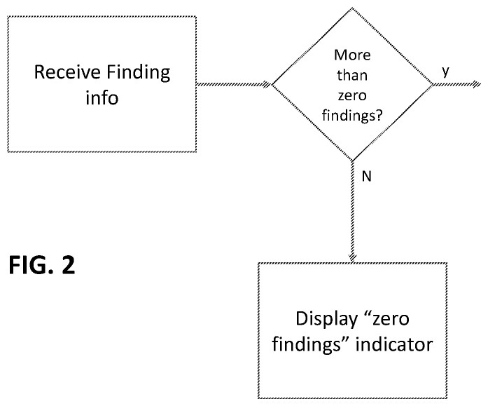

With reference to FIGS. 1 and 2, an indicator of “No Findings” or “Findings” may take a number of forms (and which may be used alone or in combination with other forms described herein):

1. An indication (e.g., symbol 12) displayed on the display screen 10 when a user first loads a case or stack of images indicating that no findings are detected (e.g., the stack of images have been processed for findings and there are none). Symbol 10 may include a bar, “X”, or other indication of no findings.
2. In some examples, the indication (e.g., symbol 12) stays on the entire time the case is being viewed indicating no findings detected.
3. An indication (e.g., number 14) indicating the count of detected findings (in which case zero indicates the stack of images has been analyzed but there are no findings). In other examples, an indication may include a check mark or other indication to indicate findings are found, with or without an indication of the number of findings.
4. From a list of studies 20 (e.g., prior to loading and displaying images), an indication (e.g., symbol 12) may be used for a given study indicating no findings detected so the study does not need to be loaded into a viewing application (e.g., diagnostic viewing workstation, separate AI visualization application, etc.), an indication 14, indicating a number of findings (e.g., 0, 1, 2, etc. findings).
5. In some examples, the process and method automatically triggers a study status change to indicate that no findings were detected so other actions can be triggered or avoided (e.g., altering the priority order of studies in the worklist, automatically loading a viewing application (e.g. diagnostic viewing workstation, separate AI visualization application, etc.)).

FIG. 2 illustrates an exemplary process for indicating findings for a stack of medical images as described. In particular, the process first determines if a stack of medical images has been analyzed for findings, and in accordance with a determination that the stack of medical images has not been analyzed for findings, displaying an indication that the stack of medical images has not been analyzed. Further, in accordance with a determination that the stack of medical images has been analyzed for findings, determining a number of findings and displaying an indication that the stack of medical images has been analyzed for findings, displaying an indication of the number of findings or that there are no findings. This allows a physician or other user to quickly determine which stack of medical images have findings and may need further review and which still await processing. Such processes can also be used when viewing a list of studies related to stacks of medical images, which may assist the user in prioritizing workflow to those studies where findings have been found.

Various embodiments described herein may be carried out by computer devices, medical imaging systems, and computer-readable medium comprising instructions for carrying out the described methods.

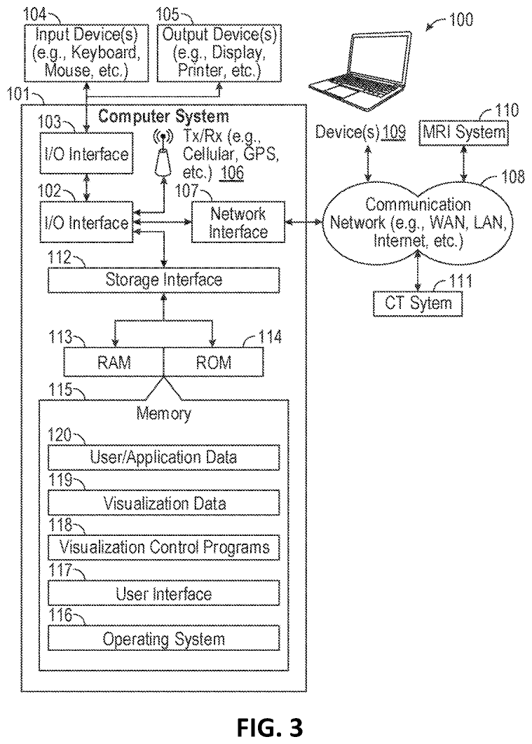

FIG. 3 illustrates an exemplary system 100 for visualization of medical images, consistent with some embodiments of the present disclosure. System 100 may include a computer system 101, input devices 104, output devices 105, devices 109, Magnet Resonance Imaging (MRI) system 110, and Computer Tomography (CT) system 111. It is appreciated that one or more components of system 100 can be separate systems or can be integrated systems. In some embodiments, computer system 101 may comprise one or more central processing units (“CPU” or “processor(s)”) 102. Processor(s) 102 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 102 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor(s) 102 may be disposed in communication with one or more input/output (I/O) devices via I/O interface 203. I/O interface 103 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 103, computer system 101 may communicate with one or more I/O devices. For example, input device 104 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, electrical pointing devices, etc. Output device 105 may be a printer, fax machine, video display (e.g., cathode ray tube (CRT), liquid crystal display (LCD), light-emitting diode (LED), plasma, or the like), audio speaker, etc. In some embodiments, a transceiver 106 may be disposed in connection with the processor(s) 102. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor(s) 102 may be disposed in communication with a communication network 108 via a network interface 107. Network interface 107 may communicate with communication network 108. Network interface 107 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 108 may include, without limitation, a direct interconnection, local area network (LAN), wide area network (WAN), wireless network (e.g., using Wireless Application Protocol), the Internet, etc. Using network interface 107 and communication network 108, computer system 101 may communicate with devices 109. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer system 101 may itself embody one or more of these devices.

In some embodiments, using network interface 107 and communication network 108, computer system 101 may communicate with MRI system 110, CT system 111, or any other medical imaging systems. Computer system 101 may communicate with these imaging systems to obtain images for display. Computer system 101 may also be integrated with these imaging systems.

In some embodiments, processor 102 may be disposed in communication with one or more memory devices (e.g., RAM 213, ROM 214, etc.) via a storage interface 112. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, flash devices, solid-state drives, etc.

The memory devices may store a collection of program or database components, including, without limitation, an operating system 116, user interface 117, medical visualization program 118, visualization data 119 (e.g., tie data, registration data, colorization, etc.), user/application data 120 (e.g., any data variables or data records discussed in this disclosure), etc. Operating system 116 may facilitate resource management and operation of computer system 101. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 117 may facilitate display, execution, interaction, manipulation, or operation of program components through textual or graphical facilities. For example, user interfaces may provide computer interaction interface elements on a display system operatively connected to computer system 101, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, computer system 101 may implement medical imaging visualization program 118 for controlling the manner of displaying medical scan images. In some embodiments, computer system 101 can implement medical visualization program 118 such that the plurality of images are displayed as described herein.

In some embodiments, computer system 101 may store user/application data 120, such as data, variables, and parameters (e.g., one or more parameters for controlling the displaying of images) as described herein. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination

It should be noted that, despite references to particular computing paradigms and software tools herein, the computer program instructions with which embodiments of the present subject matter may be implemented may correspond to any of a wide variety of programming languages, software tools and data formats, and be stored in any type of volatile or nonvolatile, non-transitory computer-readable storage medium or memory device, and may be executed according to a variety of computing models including, for example, a client/server model, a peer-to-peer model, on a stand-alone computing device, or according to a distributed computing model in which various of the functionalities may be effected or employed at different locations. In addition, references to particular algorithms herein are merely by way of examples. Suitable alternatives or those later developed known to those of skill in the art may be employed without departing from the scope of the subject matter in the present disclosure.

It will be understood by those skilled in the art that changes in the form and details of the implementations described herein may be made without departing from the scope of this disclosure. In addition, although various advantages, aspects, and objects have been described with reference to various implementations, the scope of this disclosure should not be limited by reference to such advantages, aspects, and objects. Rather, the scope of this disclosure should be determined with reference to the appended claims.

What is claimed is:

1. A computer-implemented method for indicating findings for a stack of medical images, the method comprising:
determining if a stack of medical images has been analyzed for findings; and
in accordance with a determination that the stack of medical images has been analyzed for findings and no findings have been found, displaying an indication that the stack of medical images has no findings.

2. The method of claim 1, further comprising: in accordance with a determination that the stack of medical images has not been analyzed for findings, displaying an indication that the stack of medical images has not been analyzed.

3. The method of claim 1, further comprising: in accordance with a determination that the stack of medical images has been analyzed for findings, displaying an indication of the number of findings.

4. The method of claim 1, further comprising: in accordance with a determination that the stack of medical images has been analyzed for findings, display an indication that the stack of medical images has been analyzed and an indication of the process used to analyze the stack of medical images.

5. The method of claim 1, wherein the stack of images is analyzed with a computer aided detection algorithm for identifying areas of interest in medical images.

6. The method of claim 1, wherein the stack of images is analyzed with an artificial intelligence algorithm for identifying areas of interest in medical images.

7. The method of claim 1, wherein the stack of images is analyzed with a machine learning algorithm for identifying areas of interest in medical images.

8. A computer readable storage medium comprising instructions for:
determining if a stack of medical images has been analyzed for findings; and
in accordance with a determination that the stack of medical images has been analyzed for findings and no findings have been found, displaying an indication that the stack of medical images has no findings.

9. The computer readable storage medium of claim 8, further comprising instructions for: in accordance with a determination that the stack of medical images has not been analyzed for findings, displaying an indication that the stack of medical images has not been analyzed.

10. The computer readable storage medium of claim 8, further comprising instructions for: in accordance with a determination that the stack of medical images has been analyzed for findings, displaying an indication of the number of findings.

11. The computer readable storage medium of claim 8, further comprising instructions for: in accordance with a determination that the stack of medical images has been analyzed for findings, display an indication that the stack of medical images has been analyzed and an indication of the process used to analyze the stack of medical images.

12. The computer readable storage medium of claim 8, wherein the stack of images is analyzed with a computer aided detection algorithm for identifying areas of interest in medical images.

13. The computer readable storage medium of claim 8, wherein the stack of images is analyzed with an artificial intelligence algorithm for identifying areas of interest in medical images.

14. The computer readable storage medium of claim 8, wherein the stack of images is analyzed with a machine learning algorithm for identifying areas of interest in medical images.

15. A system for indicating findings for a stack of medical images, the system comprising a processor and memory, the memory storing instructions for:
determining if a stack of medical images has been analyzed for findings; and
in accordance with a determination that the stack of medical images has been analyzed for findings and no findings have been found, displaying an indication that the stack of medical images has no findings.

16. The system of claim 15, further comprising instructions for: in accordance with a determination that the stack of medical images has not been analyzed for findings, displaying an indication that the stack of medical images has not been analyzed.

17. The system of claim 15, further comprising instructions for: in accordance with a determination that the stack of medical images has been analyzed for findings, displaying an indication of the number of findings.

18. The system of claim 15, further comprising instructions for: in accordance with a determination that the stack of medical images has been analyzed for findings, display an indication that the stack of medical images has been analyzed and an indication of the process used to analyze the stack of medical images.

19. The system of claim 15, wherein the stack of images is analyzed with a computer aided detection algorithm for identifying areas of interest in medical images.

20. The system of claim 15, wherein the stack of images is analyzed with an artificial intelligence algorithm for identifying areas of interest in medical images.

21. The system of claim 15, wherein the stack of images is analyzed with a machine learning algorithm for identifying areas of interest in medical images.
